(19) United States
(12) Patent Application Publication
(10) Pub. No.: US 2024/0015179 A1
(43) Pub. Date: Jan. 11, 2024

(54) SYSTEMS AND METHODS FOR IDENTIFYING WEBSITE CONTENT MANIPULATION

(71) Applicant: GEN DIGITAL INC., Tempe, AZ (US)

(72) Inventor: Joshua Opos, Culver City, CA (US)

(21) Appl. No.: 16/828,529

(22) Filed: Mar. 24, 2020

(51) Int. Cl. H04L 29/06; G06F 16/951

(52) U.S. Cl. CPC H04L 63/1483; H04L 63/1416; H04L 63/1433; H04L 63/0272; G06F 16/951

(57) ABSTRACT

The disclosed computer-implemented method for identifying website content manipulation may include (i) receiving a request for website content from a website and (ii) performing a security action that may include: (a) requesting the website content from the website via a first network interface device (NID); (b) requesting the website content from the website via a second NID, where the first NID and the second NID use different types of hardware interface technologies; (c) receiving first received content via the first NID; (d) receiving second received content via the second NID; (e) comparing the first received content to the second received content; and (f) identifying a probability of web content manipulation based on a degree of mismatch between the first received content and the second received content. Various other methods, systems, and computer-readable media are also disclosed.

### BACKGROUND

Content manipulation is a way for malicious actors to inject malicious content into web traffic in order to harm user devices and/or users. In some examples, man-in-the-middle attacks may inject malicious content into web traffic at intermediate locations along a path by which web content takes between originating servers and user devices. Detecting content manipulation on mobile devices may be challenging because some malicious actors do not manipulate all responses to website requests. For example, some malicious actors may not manipulate website content originating from known good sites that may be used to check for malicious actors who inject malicious content into web traffic.

The present disclosure, therefore, identifies and addresses a need for systems and methods for identifying website content manipulation.

### SUMMARY

As will be described in greater detail below, the present disclosure describes various systems and methods for identifying website content manipulation.

In one example, a method for identifying website content manipulation may include (i) receiving, at a computing device, a request for website content from a website and (ii) performing, at the computing device, a security action. In some examples, the security action may include (a) requesting the website content from the website via a first network interface device; (b) requesting the website content from the website via a second network interface device, wherein the first network interface device and the second network interface device use different types of hardware interface technologies; (c) receiving first received content via the first network interface device in response to requesting the website content from the website via the first network interface device; (d) receiving second received content via the second network interface device in response to requesting the website content from the website via the second network interface device; (e) comparing the first received content to the second received content; and (f) identifying a probability of web content manipulation based on a degree of mismatch between the first received content and the second received content.

In an example, (i) the first network interface device may include a cellular wireless interface device, a Bluetooth-compatible wireless interface device, or a Wi-Fi wireless interface device and (ii) the second network interface device may include a cellular wireless interface device, a Bluetooth-compatible wireless interface device, or a Wi-Fi wireless interface device. In some embodiments, the first network interface device may be a Wi-Fi wireless interface device and the method may further include detecting the first network interface device is connected to an untrusted Wi-Fi network. In an embodiment, the security action may be performed randomly when first network interface device or the second network interface device is a cellular wireless interface device.

In some examples, the method may include (i) receiving an indication the website is compromised and (ii) performing the security action in response to receiving the indication the website is compromised.

In an example, the method may include using (i) a first virtual private network connection to request the website information from the website via the first network interface device and (ii) a second virtual private network connection to request the website information from the website via the second network interface device.

In some embodiments, the comparing may further include comparing HyperText Markup Language code between the first received content and the second received content. In an embodiment, the comparing may include comparing JavaScript code between the first received content and the second received content. In an example, probability of a presence of web content manipulation may be high when JavaScript in the first received content does not match JavaScript in the second received content.

In some examples, the security action may include excluding advertising content from at least one of the first received content or the second received content prior to performing the comparing.

In some embodiments, the security action may further include presenting, on a display device and in response to the probability of web content manipulation exceeding a threshold, a message to switch to a virtual private network. In an embodiment, the security action may further include disconnecting from at least one of a Wi-Fi network, a Bluetooth-compatible wireless interface device, or a cellular network in response to the probability of web content manipulation exceeding a threshold.

In one embodiment, a system for identifying website content manipulation may include at least one physical processor and physical memory that includes computer-executable instructions that, when executed by the physical processor, cause the physical processor to (i) receive, at the system, a request for website content from a website and (ii) perform, at the system, a security action. In some examples, the security action may include (a) requesting the website content from the website via a first network interface device; (b) requesting the website content from the website via a second network interface device, wherein the first network interface device and the second network interface device use different types of hardware interface technologies; (c) receiving first received content via the first network interface device in response to requesting the website content from the website via the first network interface device; (d) receiving second received content via the second network interface device in response to requesting the website content from the website via the second network interface device; (e) comparing the first received content to the second received content; and (f) identifying a probability of web content manipulation based on a degree of mismatch between the first received content and the second received content.

In some examples, the above-described method may be encoded as computer-readable instructions on a non-transitory computer-readable medium. For example, a computer-readable medium may include one or more computer-executable instructions that, when executed by at least one processor of a computing device, may cause the computing device to (i) receive, at a computing device, a request for website content from a website and (ii) perform, at the computing device, a security action. In some examples, the security action may include (a) requesting the website content from the website via a first network interface device; (b) requesting the website content from the website via a second network interface device, wherein the first network interface device and the second network interface device use different types of hardware interface technologies; (c) receiving first received content via the first network interface device in response to requesting the website content from the website via the first network interface device; (d) receiving second received content via the second network interface device in response to requesting the website content from the website via the second network interface device; (e) comparing the first received content to the second received content; and (f) identifying a probability of web content manipulation based on a degree of mismatch between the first received content and the second received content.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a block diagram of an example system for identifying website content manipulation.

FIG. 2 is a block diagram of an additional example system for identifying website content manipulation.

FIG. 3 is a flow diagram of an example method for identifying website content manipulation.

FIG. 4 is a block diagram of an example message on a user display device.

FIG. 5 is a block diagram of an example computing system capable of implementing one or more of the embodiments described and/or illustrated herein.

FIG. 6 is a block diagram of an example computing network capable of implementing one or more of the embodiments described and/or illustrated herein.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE EMBODIMENTS

The present disclosure is generally directed to systems and methods for identifying website content manipulation. As will be explained in greater detail herein, in some examples the systems described herein may automatically and/or in real-time detect manipulation of web content. In some examples, the provided methods may use VPN technology (e.g., xNDC on iOS-compatible devices) to request duplicate web traffic from multiple (e.g., two) different interface devices (e.g., Wi-Fi, and Cellular). In some embodiments, when devices are connected to compromised Wi-Fi networks and malicious content is injected, the web content of the duplicate streams will be different. Thus, attacks may be detected on web content transiting from any websites by comparing web content from the same originating websites received via the different interface devices at user devices. In some examples, the provided techniques may be combined with other heuristic algorithms, such as web acceleration and/or ad blocking to improve performance, to remove benign web content manipulations, reduce possibilities of false positives, and/or improve accuracy. In some examples, systems may deploy the provided techniques randomly and/or when connected to untrusted Wi-Fi networks (e.g., when not connected to home networks) to save battery power and/or reduce data usage.

By doing so, the systems and methods described herein may improve functioning of computing devices (i.e., user devices), improve cybersecurity protection provided to computing devices, and/or provide targeted protection against malware, and thus improve fields of malware protection in general, by providing a method for automatically increasing cybersecurity protection of computing devices. Examples of the provided techniques may improve a state of security of computing devices, potentially resulting in significant time and/or monetary savings. Further, systems and methods described herein may beneficially reduce and/or eliminate gaps in time during which computing devices have reduced levels of cybersecurity protection, when compared to other techniques. In some examples, the provided systems and methods may improve functioning of protected computing devices by providing increased cybersecurity protection to the protected computing devices. Further, the provided techniques do not require web content that is from known good sites in order to detect manipulated web content. Thus, disclosed systems and methods may provide protection for common targets of malware.

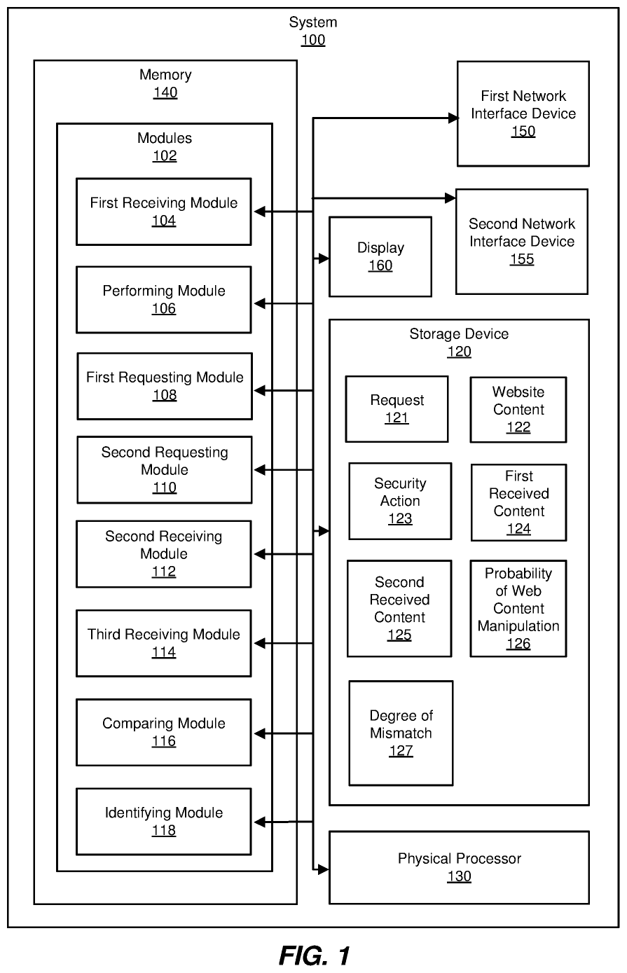

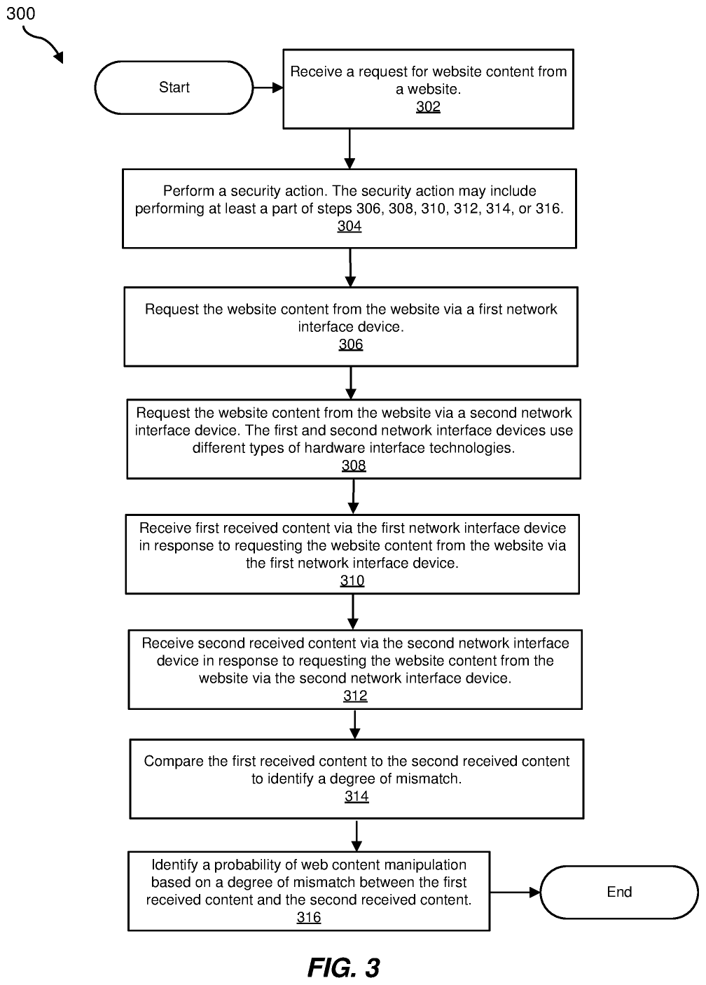

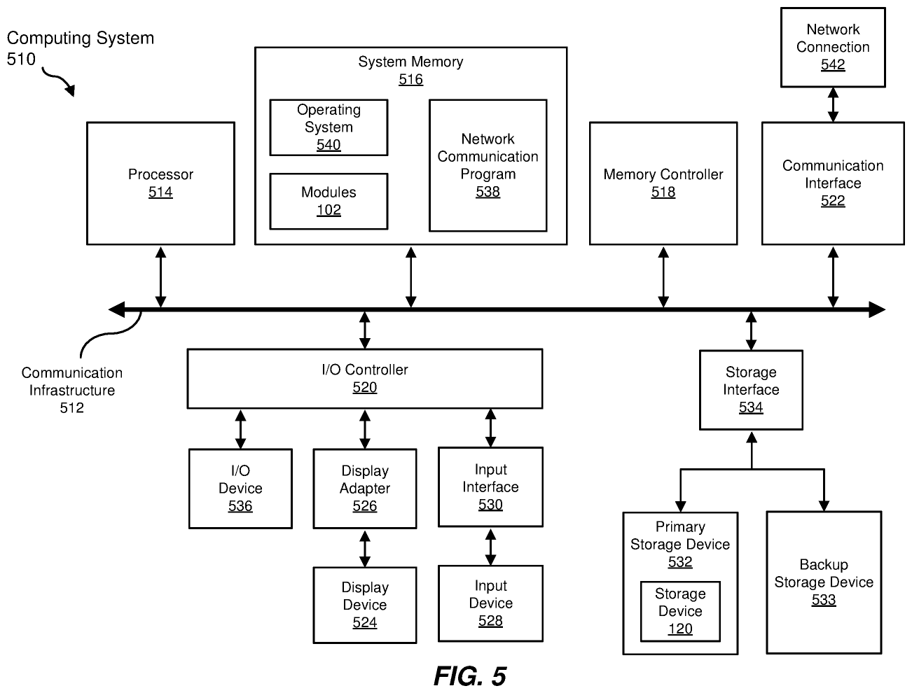

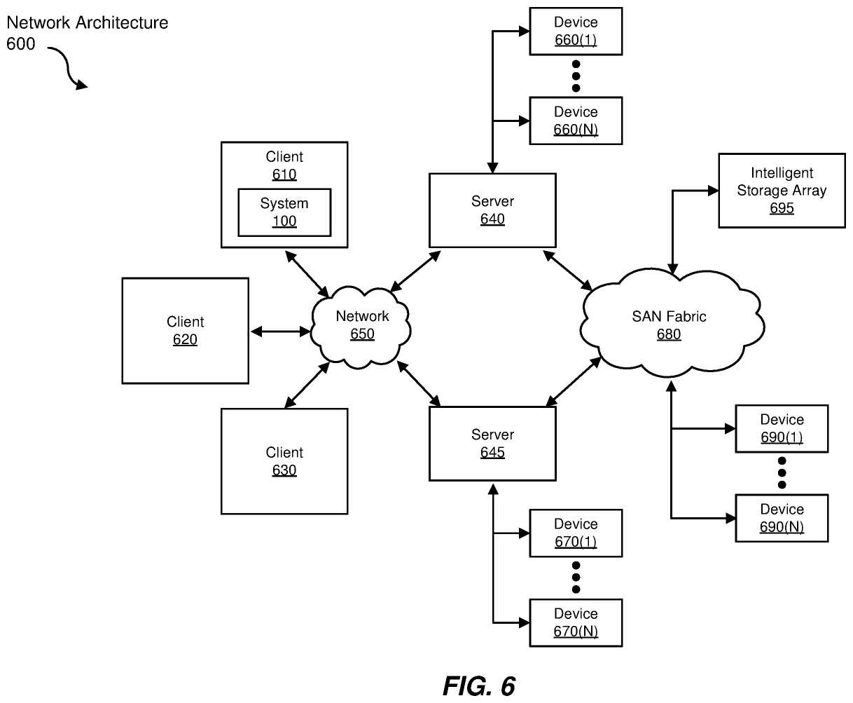

The following will provide, with reference to FIGS. 1-2 and 4, detailed descriptions of example systems for identifying website content manipulation. Detailed descriptions of corresponding computer-implemented methods will also be provided in connection with FIG. 3. In addition, detailed descriptions of an example computing system and network architecture capable of implementing one or more of the embodiments described herein will be provided in connection with FIGS. 5 and 6, respectively.

FIG. 1 is a block diagram of an example system 100 for identifying website content manipulation. As illustrated in this figure, example system 100 may include one or more modules 102 for performing one or more tasks. As will be explained in greater detail below, modules 102 may include a first receiving module 104, a performing module 106, a first requesting module 108, a second requesting module 110, a second receiving module 112, a third receiving module 114, a comparing module 116, and an identifying module 118. Although illustrated as separate elements, one or more of modules 102 in FIG. 1 may represent portions of a single module or application.

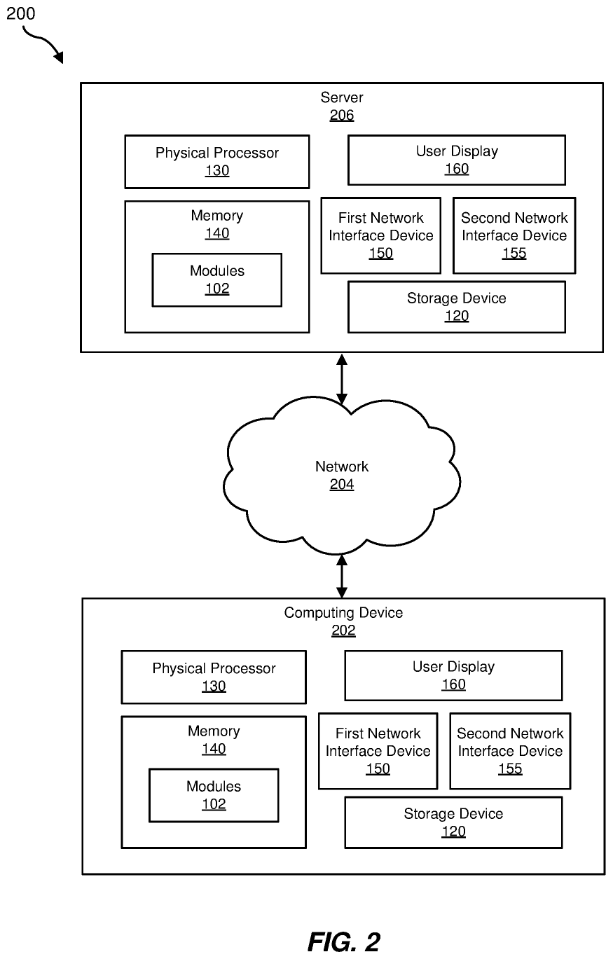

In certain embodiments, one or more of modules 102 in FIG. 1 may represent one or more software applications or programs that, when executed by a computing device, may cause the computing device to perform one or more tasks. For example, and as will be described in greater detail below, one or more of modules 102 may represent modules stored and configured to run on one or more computing devices, such as the devices illustrated in FIG. 2 (e.g., computing device 202 and/or server 206). One or more of modules 102 in FIG. 1 may also represent all or portions of one or more special-purpose computers configured to perform one or more tasks.

As illustrated in FIG. 1, example system 100 may also include one or more tangible storage devices, such as storage device 120. Storage device 120 generally represents any type or form of volatile or non-volatile storage device or medium capable of storing data and/or computer-readable instructions. In one example, storage device 120 may store, load, and/or maintain information indicating one or more of a request 121, website content 122, a security action 123, first received content 124, second received content 125, a probability of web content manipulation 126, and/or a degree of mismatch 127. In some examples, storage device 120 may generally represent multiple storage devices. Examples of storage device 120 include, without limitation, Random Access Memory (RAM), Read Only Memory (ROM), flash memory, Hard Disk Drives (HDDs), Solid-State Drives (SSDs), optical disk drives, caches, a cloud-based storage device, an attached storage device, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of modules 102 stored in memory 140. Additionally or alternatively, physical processor 130 may execute one or more of modules 102 to facilitate identifying website content manipulation. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more network adapters, such as a first network interface device 150 and a second network interface device 155. In some examples, first network interface device 150 may be a physical network adapter connected to a physical network (e.g., network 204 in FIG. 2). In some examples, second network interface device 155 may be a physical network adapter connected to a physical network (e.g., network 204 in FIG. 2). In some examples, first network interface device 150 and second network interface device 155 may use different types of hardware interface technologies.

As illustrated in FIG. 1, example system 100 may also include one or more display devices, such as display 160. Display 160 generally represents any type or form of device capable of visually displaying information (e.g., to a user). In some examples, display 160 may present a graphical user interface. In non-limiting examples, display 160 may present at least a portion of information indicating one or more of request 121, website content 122, security action 123, first received content 124, second received content 125, probability of web content manipulation 126, and/or degree of mismatch 127.

Example system 100 in FIG. 1 may be implemented in a variety of ways. For example, all or a portion of example system 100 may represent portions of example system 200 in FIG. 2. As shown in FIG. 2, system 200 may include a computing device 202 in communication with a server 206 via a network 204. In one example, all or a portion of the functionality of modules 102 may be performed by computing device 202, server 206, and/or any other suitable computing system. As will be described in greater detail below, one or more of modules 102 from FIG. 1 may, when executed by at least one processor of computing device 202 and/or server 206, enable computing device 202 and/or server 206 to identify website content manipulation. For example, and as will be described in greater detail below, one or more of modules 102 may cause computing device 202 and/or server 206 to (i) receive, at system 100, request 121 for website content 122 from a website and (ii) performing, at system 100, security action 123. In some examples, security action 123 may include (a) requesting website content 122 from the website via first network interface device 150; (b) requesting website content 122 from the website via second network interface device 155, wherein first network interface device 150 and second network interface device 155 use different types of hardware interface technologies; (c) receiving first received content 124 via first network interface device 150 in response to requesting website content 122 from the website via first network interface device 150; (d) receiving second received content 125 via second network interface device 155 in response to requesting the website content from the website via second network interface device 155; (e) comparing first received content 124 to second received content 125; and (f) identifying probability of web content manipulation 126 based on degree of mismatch 127 between first received content 124 and second received content 125.

Computing device 202 generally represents any type or form of computing device capable of reading computer-executable instructions. In some examples, computing device 202 may represent a computer running security software, such as cybersecurity software and/or privacy software. Additional examples of computing device 202 include, without limitation, laptops, tablets, desktops, servers, cellular phones, Personal Digital Assistants (PDAs), multimedia players, embedded systems, wearable devices (e.g., smart watches, smart glasses, etc.), smart vehicles, smart packaging (e.g., active or intelligent packaging), gaming consoles, so-called Internet-of-Things devices (e.g., smart appliances, etc.), variations or combinations of one or more of the same, and/or any other suitable computing device.

Network 204 generally represents any medium or architecture capable of facilitating communication or data transfer. In one example, network 204 may facilitate communication between computing device 202 and server 206. In this example, network 204 may facilitate communication or data transfer using wireless and/or wired connections. Examples of network 204 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), a Bluetooth network, portions of one or more of the same, variations or combinations of one or more of the same, and/or any other suitable network. In some examples, network 204 may include at least two different types of network hardware (e.g., Wi-Fi and Cellular). In some embodiments, each type of network hardware may be at least a part of different networks.

Server 206 generally represents any type or form of computing device that is capable of reading computer-executable instructions. In some examples, server 206 may represent a computer running security software, such as cybersecurity software and/or privacy software. Additional examples of server 206 include, without limitation, security servers, application servers, web servers, storage servers, and/or database servers configured to run certain software applications and/or provide various security, web, storage, and/or database services. Although illustrated as a single entity in FIG. 2, server 206 may include and/or represent a plurality of servers that work and/or operate in conjunction with one another.

FIG. 3 is a flow diagram of an example computer-implemented method 300 for identifying website content manipulation. The steps shown in FIG. 3 may be performed by any suitable computer-executable code and/or computing system, including system 100 in FIG. 1, system 200 in FIG. 2, and/or variations or combinations of one or more of the same. In one example, each of the steps shown in FIG. 3 may represent an algorithm whose structure includes and/or is represented by multiple sub-steps, examples of which will be provided in greater detail below.

As illustrated in FIG. 3, at step 302 one or more of the systems described herein may receive requests for website content (e.g., website content retrievable from websites). The systems described herein may perform step 302 in a variety of ways. For example, first receiving module 104 may, as part of computing device 202 and/or server 206 in FIG. 2, receive (e.g., at system 100), request 121 for website content 122. In one example, website content 122 may be retrievable from a website.

As illustrated in FIG. 3, at step 304 one or more of the systems described herein may perform security actions. The one or more of the systems described herein may perform the security actions in response to receiving the requests for website content. The security actions may include performing at least a portion of steps 306, 308, 310, 312, 314, and/or 316. The systems described herein may perform step 304 in a variety of ways. For example, performing module 106 may, as part of computing device 202 and/or server 206 in FIG. 2, perform (e.g., at system 100), security action 123. In one example, performing security action 123 may include performing at least a portion of steps 306, 308, 310, 312, 314, and/or 316.

In some examples, the security actions may be performed randomly, such as when the first network interface device or the second network interface device is a cellular wireless interface device. Randomly performing the security actions may advantageously provide added security while using a lower quantity of bandwidth and/or transferring a lower quantity of data.

In some embodiments, method 300 may further include (i) receiving indications the websites are compromised and (ii) performing the security actions in response to receiving the indications the websites are compromised.

In some embodiments, method 300 may include detecting the first network interface device is connected to an untrusted Wi-Fi network. In an example, method 300 may include performing the security actions in response to detecting the first network interface device is connected to an untrusted Wi-Fi network. In an embodiment, method 300 may include performing the security actions in response to detecting the second network interface device is connected to an untrusted Wi-Fi network.

In examples, security actions may include prophylactic measures taken to safeguard electronic information. Prophylactic measures may include acts undertaken to prevent, detect, and/or mitigate vulnerabilities of electronic computing devices, to implement computer security policies (e.g., identifying web content manipulation), to detect malicious activities on electronic computing devices, and/or to thwart malicious activities on electronic computing devices. In some examples, method 300 may further include performing security actions in attempts to ameliorate potential security risks. For example, the provided modules may identify potential security risks and in response may perform security actions in attempts to ameliorate the potential security risks.

As illustrated in FIG. 3, at step 306 one or more of the systems described herein may request the website content from the websites via first network interface devices. The systems described herein may perform step 306 in a variety of ways. For example, first requesting module 108 may, as part of computing device 202 and/or server 206 in FIG. 2, request website content 122 from the website via first network interface device 150.

In some examples, the first network interface device may be a Wi-Fi wireless interface device. In some embodiments, the first network interface device may be a Bluetooth wireless interface device. In some embodiments, the first network interface device may be a cellular wireless interface device.

As illustrated in FIG. 3, at step 308 one or more of the systems described herein may request the website content from the websites via second network interface devices. The first network interface devices and the second network interface devices may use different types of hardware interface technologies. The systems described herein may perform step 308 in a variety of ways. For example, second requesting module 110 may, as part of computing device 202 and/or server 206 in FIG. 2, request website content 122 from the website via second network interface device 155. In some examples, first network interface device 150 and second network interface device 155 may use different types of hardware interface technologies.

In some examples, the second network interface device may be a Wi-Fi wireless interface device. In some embodiments, the second network interface device may be a Bluetooth wireless interface device. In some embodiments, the second network interface device may be a cellular wireless interface device. In some embodiments, the first network interface device and the second network interface device may be simultaneously active.

In some embodiments, step 306 and step 308 may be performed simultaneously. In some embodiments, step 306 and step 308 may be performed substantially simultaneously.

The term “different types of hardware interface technologies,” as used herein, generally refers to hardware interfaces that are not compatible with each other due to tangible differences in interface hardware, wireless communication frequencies used to communicate information, and/or communication protocols. Examples of different types of hardware interface technologies include, without limitation, Wi-Fi hardware interface devices, Bluetooth-compatible interface devices, and cellular hardware interface devices. For example, if a radio frequency (RF)output of a Wi-Fi hardware interface device is received by an RF front end of a cellular hardware interface device, the cellular hardware interface device is not able to decode, decrypt, and/or convert the RF output of the Wi-Fi hardware interface device to a usable form.

As illustrated in FIG. 3, at step 310 one or more of the systems described herein may receive first received content via the first network interface devices (e.g., in response to requesting the website content from the websites via the first network interface devices). The systems described herein may perform step 310 in a variety of ways. For example, second receiving module 112 may, as part of computing device 202 and/or server 206 in FIG. 2, receive first received content 124 via first network interface device 150 in response to requesting website content 122 from the website via first network interface device 150.

As illustrated in FIG. 3, at step 312 one or more of the systems described herein may receive second received content via the second network interface devices (e.g., in response to requesting the website content from the websites via the second network interface devices). The systems described herein may perform step 312 in a variety of ways. For example, third receiving module 114 may, as part of computing device 202 and/or server 206 in FIG. 2, receive second received content 125 via second network interface device 155 in response to requesting the website content from the website via second network interface device 155.

As illustrated in FIG. 3, at step 314 one or more of the systems described herein may compare the first received content to the second received content (e.g., to identify degrees of mismatches between the first received content and the second received content). The systems described herein may perform step 314 in a variety of ways. For example, comparing module 116 may, as part of computing device 202 and/or server 206 in FIG. 2, compare first received content 124 to second received content 125.

In some examples, the comparing may identify degrees of mismatches between the first received content and the second received content.

In some examples, method 300 may further include using first virtual private network connections to request the website information from the websites via the first network interface devices. In some examples, method 300 may further include using second virtual private network connections to request the website information from the websites via the second network interface devices.

In some embodiments, the comparing may include comparing HyperText Markup Language code between the first received content and the second received content. In an embodiment, the comparing may include comparing JavaScript code between the first received content and the second received content. In some examples, the comparing may include performing string comparisons of received content. In some examples, the comparing may include character-by-character comparison of code, with per-character mismatches increasing degrees of mismatches between the first received content and the second received content. In some embodiments, per-character mismatches may indicate web content manipulation being performed on web content received by one of the network interface devices. In some examples, per-character mismatches may indicate web content manipulation being performed on web content received by one of the network interface devices but not on web content received by another network interface device.

In some embodiments, the security actions may further include excluding benign content from at least one of the first received content or the second received content prior to performing the comparing. In some embodiments, the security actions may further include excluding advertising content from at least one of the first received content or the second received content prior to performing the comparing. Different advertisements may be added to the first received content and/or the second received content, thus removing advertising content prior to comparing may advantageously reduce false positive indications of website content manipulation, may advantageously reduce false positive indications of malicious website content, and/or increase accuracy of probabilities of web content manipulation.

As illustrated in FIG. 3, at step 316 one or more of the systems described herein may identify probabilities of web content manipulation based on degrees of mismatches between the first received content and the second received content. The systems described herein may perform step 316 in a variety of ways. For example, identifying module 118 may, as part of computing device 202 and/or server 206 in FIG. 2, identify probability of web content manipulation 126 based on degree of mismatch 127 between first received content 124 and second received content 125.

In one example, probabilities of a presence of web content manipulation may be high when JavaScript in the first received content does not match JavaScript in the second received content.

In some examples, the security actions may further include presenting, on a display device (e.g., a touchscreen, a video display, display 160) and in response to the probabilities of web content manipulation exceeding thresholds, warning messages indicating detection of web content manipulation, messages instructing users to switch to virtual private networks, messages instructing users to disconnect from Wi-Fi networks, messages instructing users to disconnect from Bluetooth devices, and/or messages instructing users to disconnect from cellular networks.

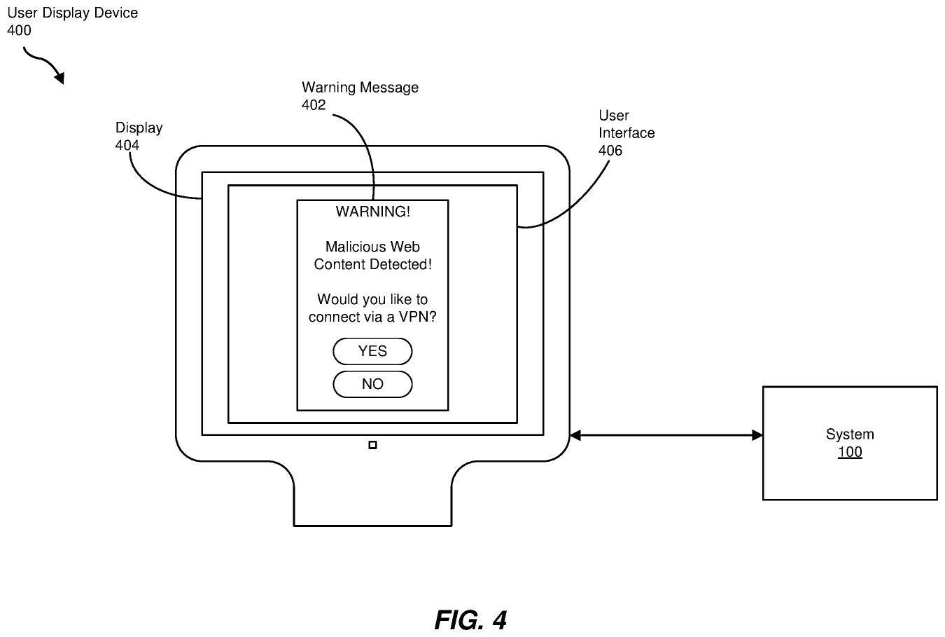

We turn now to FIG. 4.

FIG. 4 depicts an example of a user display device 400 including display 404 (e.g., display 160) which may present user interface 406. In this example, user display device 400 may display cybersecurity-related message 402. In some examples, cybersecurity-related message 402 may include warning messages indicating detection of web content manipulation, messages instructing users to switch to virtual private networks, messages instructing users to disconnect from Wi-Fi networks, messages instructing users to disconnect from Bluetooth devices, and/or messages instructing users to disconnect from cellular networks. In some examples, user display device 400 may be integrated with system 100 in the same device, such as a mobile device.

We now return to FIG. 3.

In some examples, the security actions may further include disconnecting from at least one of a Wi-Fi network, a Bluetooth network, or a cellular network in response to the probabilities of web content manipulation exceeding thresholds. In a non-limiting example, if a degree of code mismatch is 12%, then a corresponding probability of web content manipulation is 75%, which is higher than a threshold probability of 10%, thus triggering disconnecting from at least one of a Wi-Fi network or a cellular network. In an example, the method 300 may further include receiving user inputs indicating values of the thresholds. In some examples, the disconnecting may be automatically performed in response to the probabilities of web content manipulation exceeding the thresholds.

As detailed above, the steps outlined in method 300 in FIG. 3 may enable computing devices to increase cybersecurity protection. In some examples the systems described herein may enable automatically detecting manipulation of web content. In some examples, the provided methods may detect attacks on web content transiting from websites by comparing web content from the same originating websites received via different interface devices at computing devices. In some examples, the systems and methods described herein may thus improve functioning of computing devices, improve cybersecurity protection provided to computing devices, and/or provide targeted protection against malware, and thus improve fields of malware protection in general, by providing a method for automatically increasing cybersecurity protection of computing devices.

FIG. 5 is a block diagram of an example computing system 510 capable of implementing one or more of the embodiments described and/or illustrated herein. For example, all or a portion of computing system 510 may perform and/or be a means for performing, either alone or in combination with other elements, one or more of the steps described herein (such as one or more of the steps illustrated in FIG. 3). All or a portion of computing system 510 may also perform and/or be a means for performing any other steps, methods, or processes described and/or illustrated herein.

Computing system 510 broadly represents any single or multi-processor computing device or system capable of executing computer-readable instructions. Examples of computing system 510 include, without limitation, workstations, laptops, client-side terminals, servers, distributed computing systems, handheld devices, or any other computing system or device. In its most basic configuration, computing system 510 may include at least one processor 514 and a system memory 516.

Processor 514 generally represents any type or form of physical processing unit (e.g., a hardware-implemented central processing unit) capable of processing data or interpreting and executing instructions. In certain embodiments, processor 514 may receive instructions from a software application or module. These instructions may cause processor 514 to perform the functions of one or more of the example embodiments described and/or illustrated herein.

System memory 516 generally represents any type or form of volatile or non-volatile storage device or medium capable of storing data and/or other computer-readable instructions. Examples of system memory 516 include, without limitation, Random Access Memory (RAM), Read Only Memory (ROM), flash memory, or any other suitable memory device. Although not required, in certain embodiments computing system 510 may include both a volatile memory unit (such as, for example, system memory 516) and a non-volatile storage device (such as, for example, primary storage device 532, as described in detail below). In one example, one or more of modules 102 from FIG. 1 may be loaded into system memory 516.

In some examples, system memory 516 may store and/or load an operating system 540 for execution by processor 514. In one example, operating system 540 may include and/or represent software that manages computer hardware and software resources and/or provides common services to computer programs and/or applications on computing system 510. Examples of operating system 540 include, without limitation, LINUX, JUNOS, MICROSOFT WINDOWS, WINDOWS MOBILE, MAC OS, APPLE'S 10S, UNIX, GOOGLE CHROME OS, GOOGLE'S ANDROID, SOLARIS, variations of one or more of the same, and/or any other suitable operating system.

In certain embodiments, example computing system 510 may also include one or more components or elements in addition to processor 514 and system memory 516. For example, as illustrated in FIG. 5, computing system 510 may include a memory controller 518, an Input/Output (I/O) controller 520, and a communication interface 522, each of which may be interconnected via a communication infrastructure 512. Communication infrastructure 512 generally represents any type or form of infrastructure capable of facilitating communication between one or more components of a computing device. Examples of communication infrastructure 512 include, without limitation, a communication bus (such as an Industry Standard Architecture (ISA), Peripheral Component Interconnect (PCI), PCI Express (PCIe), or similar bus) and a network.

Memory controller 518 generally represents any type or form of device capable of handling memory or data or controlling communication between one or more components of computing system 510. For example, in certain embodiments memory controller 518 may control communication between processor 514, system memory 516, and I/O controller 520 via communication infrastructure 512.

I/O controller 520 generally represents any type or form of module capable of coordinating and/or controlling the input and output functions of a computing device. For example, in certain embodiments I/O controller 520 may control or facilitate transfer of data between one or more elements of computing system 510, such as processor 514, system memory 516, communication interface 522, display adapter 526, input interface 530, and storage interface 534.

As illustrated in FIG. 5, computing system 510 may also include at least one display device 524 coupled to I/O controller 520 via a display adapter 526. Display device 524 generally represents any type or form of device capable of visually displaying information forwarded by display adapter 526. Similarly, display adapter 526 generally represents any type or form of device configured to forward graphics, text, and other data from communication infrastructure 512 (or from a frame buffer, as known in the art) for display on display device 524.

As illustrated in FIG. 5, example computing system 510 may also include at least one input device 528 coupled to I/O controller 520 via an input interface 530. Input device 528 generally represents any type or form of input device capable of providing input, either computer or human generated, to example computing system 510. Examples of input device 528 include, without limitation, a keyboard, a pointing device, a speech recognition device, variations or combinations of one or more of the same, and/or any other input device.

Additionally or alternatively, example computing system 510 may include additional I/O devices. For example, example computing system 510 may include I/O device 536. In this example, I/O device 536 may include and/or represent a user interface that facilitates human interaction with computing system 510. Examples of I/O device 536 include, without limitation, a computer mouse, a keyboard, a monitor, a printer, a modem, a camera, a scanner, a microphone, a touchscreen device, variations or combinations of one or more of the same, and/or any other I/O device.

Communication interface 522 broadly represents any type or form of communication device or adapter capable of facilitating communication between example computing system 510 and one or more additional devices. For example, in certain embodiments communication interface 522 may facilitate communication between computing system 510 and a private or public network including additional computing systems. Examples of communication interface 522 include, without limitation, a wired network interface (such as a network interface card), a wireless network interface (such as a wireless network interface card), a modem, and any other suitable interface. In at least one embodiment, communication interface 522 may provide a direct connection to a remote server via a direct link to a network, such as the Internet. Communication interface 522 may also indirectly provide such a connection through, for example, a local area network (such as an Ethernet network), a personal area network, a telephone or cable network, a cellular telephone connection, a Bluetooth compatible network, a Wi-Fi compatible network, a satellite data connection, or any other suitable connection.

In certain embodiments, communication interface 522 may also represent a host adapter configured to facilitate communication between computing system 510 and one or more additional network or storage devices via an external bus or communications channel. Examples of host adapters include, without limitation, Small Computer System Interface (SCSI) host adapters, Universal Serial Bus (USB) host adapters, Institute of Electrical and Electronics Engineers (IEEE) 1394 host adapters, Advanced Technology Attachment (ATA), Parallel ATA (PATA), Serial ATA (SATA), and External SATA (eSATA) host adapters, Fibre Channel interface adapters, Ethernet adapters, or the like. Communication interface 522 may also allow computing system 510 to engage in distributed or remote computing. For example, communication interface 522 may receive instructions from a remote device or send instructions to a remote device for execution.

In some examples, system memory 516 may store and/or load a network communication program 538 for execution by processor 514. In one example, network communication program 538 may include and/or represent software that enables computing system 510 to establish a network connection 542 with another computing system (not illustrated in FIG. 5) and/or communicate with the other computing system by way of communication interface 522. In this example, network communication program 538 may direct the flow of outgoing traffic that is sent to the other computing system via network connection 542. Additionally or alternatively, network communication program 538 may direct the processing of incoming traffic that is received from the other computing system via network connection 542 in connection with processor 514.

Although not illustrated in this way in FIG. 5, network communication program 538 may alternatively be stored and/or loaded in communication interface 522. For example, network communication program 538 may include and/or represent at least a portion of software and/or firmware that is executed by a processor and/or Application Specific Integrated Circuit (ASIC) incorporated in communication interface 522.

As illustrated in FIG. 5, example computing system 510 may also include a primary storage device 532 and a backup storage device 533 coupled to communication infrastructure 512 via a storage interface 534. Storage devices 532 and 533 generally represent any type or form of storage device or medium capable of storing data and/or other computer-readable instructions. For example, storage devices 532 and 533 may be a magnetic disk drive (e.g., a so-called hard drive), a solid state drive, a floppy disk drive, a magnetic tape drive, an optical disk drive, a flash drive, or the like. Storage interface 534 generally represents any type or form of interface or device for transferring data between storage devices 532 and 533 and other components of computing system 510. In one example, storage device 120 from FIG. 1 may be at least a portion of primary storage device 532.

In certain embodiments, storage devices 532 and 533 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 532 and 533 may also include other similar structures or devices for allowing computer software, data, or other computer-readable instructions to be loaded into computing system 510. For example, storage devices 532 and 533 may be configured to read and write software, data, or other computer-readable information. Storage devices 532 and 533 may also be a part of computing system 510 or may be a separate device accessed through other interface systems.

Many other devices or subsystems may be connected to computing system 510. Conversely, all of the components and devices illustrated in FIG. 5 need not be present to practice the embodiments described and/or illustrated herein. The devices and subsystems referenced above may also be interconnected in different ways from that shown in FIG. 5. Computing system 510 may also employ any number of software, firmware, and/or hardware configurations. For example, one or more of the example embodiments disclosed herein may be encoded as a computer program (also referred to as computer software, software applications, computer-readable instructions, or computer control logic) on a computer-readable medium. The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The computer-readable medium containing the computer program may be loaded into computing system 510. All or a portion of the computer program stored on the computer-readable medium may then be stored in system memory 516 and/or various portions of storage devices 532 and 533. When executed by processor 514, a computer program loaded into computing system 510 may cause processor 514 to perform and/or be a means for performing the functions of one or more of the example embodiments described and/or illustrated herein. Additionally or alternatively, one or more of the example embodiments described and/or illustrated herein may be implemented in firmware and/or hardware. For example, computing system 510 may be configured as an Application Specific Integrated Circuit (ASIC) adapted to implement one or more of the example embodiments disclosed herein.

FIG. 6 is a block diagram of an example network architecture 600 in which client systems 610, 620, and 630 and servers 640 and 645 may be coupled to a network 650. As detailed above, all or a portion of network architecture 600 may perform and/or be a means for performing, either alone or in combination with other elements, one or more of the steps disclosed herein (such as one or more of the steps illustrated in FIG. 3). All or a portion of network architecture 600 may also be used to perform and/or be a means for performing other steps and features set forth in the present disclosure.

Client systems 610, 620, and 630 generally represent any type or form of computing device or system, such as example computing system 510 in FIG. 5. Similarly, servers 640 and 645 generally represent computing devices or systems, such as application servers or database servers, configured to provide various database services and/or run certain software applications. Network 650 generally represents any telecommunication or computer network including, for example, an intranet, a WAN, a LAN, a PAN, or the Internet. In one example, client systems 610, 620, and/or 630 and/or servers 640 and/or 645 may include all or a portion of system 100 from FIG. 1.

As illustrated in FIG. 6, one or more storage devices 660(1)-(N) may be directly attached to server 640. Similarly, one or more storage devices 670(1)-(N) may be directly attached to server 645. Storage devices 660(1)-(N) and storage devices 670(1)-(N) generally represent any type or form of storage device or medium capable of storing data and/or other computer-readable instructions. In certain embodiments, storage devices 660(1)-(N) and storage devices 670(1)-(N) may represent Network-Attached Storage (NAS) devices configured to communicate with servers 640 and 645 using various protocols, such as Network File System (NFS), Server Message Block (SMB), or Common Internet File System (CIFS).

Servers 640 and 645 may also be connected to a Storage Area Network (SAN) fabric 680. SAN fabric 680 generally represents any type or form of computer network or architecture capable of facilitating communication between a plurality of storage devices. SAN fabric 680 may facilitate communication between servers 640 and 645 and a plurality of storage devices 690(1)-(N) and/or an intelligent storage array 695. SAN fabric 680 may also facilitate, via network 650 and servers 640 and 645, communication between client systems 610, 620, and 630 and storage devices 690(1)-(N) and/or intelligent storage array 695 in such a manner that devices 690(1)-(N) and array 695 appear as locally attached devices to client systems 610, 620, and 630. As with storage devices 660(1)-(N) and storage devices 670(1)-(N), storage devices 690(1)-(N) and intelligent storage array 695 generally represent any type or form of storage device or medium capable of storing data and/or other computer-readable instructions.

In certain embodiments, and with reference to example computing system 510 of FIG. 5, a communication interface, such as communication interface 522 in FIG. 5, may be used to provide connectivity between each client system 610, 620, and 630 and network 650. Client systems 610, 620, and 630 may be able to access information on server 640 or 645 using, for example, a web browser or other client software. Such software may allow client systems 610, 620, and 630 to access data hosted by server 640, server 645, storage devices 660(1)-(N), storage devices 670(1)-(N), storage devices 690(1)-(N), or intelligent storage array 695. Although FIG. 6 depicts the use of a network (such as the Internet) for exchanging data, the embodiments described and/or illustrated herein are not limited to the Internet or any particular network-based environment.

In at least one embodiment, all or a portion of one or more of the example embodiments disclosed herein may be encoded as a computer program and loaded onto and executed by server 640, server 645, storage devices 660(1)-(N), storage devices 670(1)-(N), storage devices 690(1)-(N), intelligent storage array 695, or any combination thereof. All or a portion of one or more of the example embodiments disclosed herein may also be encoded as a computer program, stored in server 640, run by server 645, and distributed to client systems 610, 620, and 630 over network 650.

As detailed above, computing system 510 and/or one or more components of network architecture 600 may perform and/or be a means for performing, either alone or in combination with other elements, one or more steps of an example method for identifying website content manipulation.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 100 in FIG. 1 may represent portions of a cloud-computing or network-based environment. Cloud-computing environments may provide various services and applications via the Internet. These cloud-based services (e.g., software as a service, platform as a service, infrastructure as a service, etc.) may be accessible through a web browser or other remote interface. Various functions described herein may be provided through a remote desktop environment or any other cloud-based computing environment.

In various embodiments, all or a portion of example system 100 in FIG. 1 may facilitate multi-tenancy within a cloud-based computing environment. In other words, the software modules described herein may configure a computing system (e.g., a server) to facilitate multi-tenancy for one or more of the functions described herein. For example, one or more of the software modules described herein may program a server to enable two or more clients (e.g., customers) to share an application that is running on the server. A server programmed in this manner may share an application, operating system, processing system, and/or storage system among multiple customers (i.e., tenants). One or more of the modules described herein may also partition data and/or configuration information of a multi-tenant application for each customer such that one customer cannot access data and/or configuration information of another customer.

According to various embodiments, all or a portion of example system 100 in FIG. 1 may be implemented within a virtual environment. For example, the modules and/or data described herein may reside and/or execute within a virtual machine. As used herein, the term “virtual machine” generally refers to any operating system environment that is abstracted from computing hardware by a virtual machine manager (e.g., a hypervisor). Additionally or alternatively, the modules and/or data described herein may reside and/or execute within a virtualization layer. As used herein, the term “virtualization layer” generally refers to any data layer and/or application layer that overlays and/or is abstracted from an operating system environment. A virtualization layer may be managed by a software virtualization solution (e.g., a file system filter) that presents the virtualization layer as though it were part of an underlying base operating system. For example, a software virtualization solution may redirect calls that are initially directed to locations within a base file system and/or registry to locations within a virtualization layer.

In some examples, all or a portion of example system 100 in FIG. 1 may represent portions of a mobile computing environment. Mobile computing environments may be implemented by a wide range of mobile computing devices, including mobile phones, tablet computers, e-book readers, personal digital assistants, wearable computing devices (e.g., computing devices with a head-mounted display, smartwatches, etc.), and the like. In some examples, mobile computing environments may have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein may be provided for a mobile computing environment and/or may interact with a mobile computing environment.

In addition, all or a portion of example system 100 in FIG. 1 may represent portions of, interact with, consume data produced by, and/or produce data consumed by one or more systems for information management. As used herein, the term “information management” may refer to the protection, organization, and/or storage of data. Examples of systems for information management may include, without limitation, storage systems, backup systems, archival systems, replication systems, high availability systems, data search systems, virtualization systems, and the like.

In some embodiments, all or a portion of example system 100 in FIG. 1 may represent portions of, produce data protected by, and/or communicate with one or more systems for information security. As used herein, the term “information security” may refer to the control of access to protected data. Examples of systems for information security may include, without limitation, systems providing managed security services, data loss prevention systems, identity authentication systems, access control systems, encryption systems, policy compliance systems, intrusion detection and prevention systems, electronic discovery systems, and the like.

According to some examples, all or a portion of example system 100 in FIG. 1 may represent portions of, communicate with, and/or receive protection from one or more systems for endpoint security. As used herein, the term “endpoint security” may refer to the protection of endpoint systems from unauthorized and/or illegitimate use, access, and/or control. Examples of systems for endpoint protection may include, without limitation, anti-malware systems, user authentication systems, encryption systems, privacy systems, spam-filtering services, and the like.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

In addition, one or more of the modules described herein may transform data, physical devices, and/or representations of physical devices from one form to another. For example, one or more of the modules recited herein may receive first received content and/or second received content to be transformed, transform the received content, output a result of the transformation to a digital information storage device, use the result of the transformation to identify a probability of web content manipulation, and store the result of the transformation to a digital information storage device. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” In some examples, the singular may portend the plural. Finally, for ease of use, the terms “including” and “having” (and their derivatives), as used in the specification and claims, are interchangeable with and have the same meaning as the word “comprising.”

1. A computer-implemented method for identifying website content manipulation, at least a portion of the method being performed by a computing device comprising at least one processor, the method comprising:
receiving, at the computing device, a value of a threshold for identified differences in received web content that, when exceeded, indicates a potential security risk to the computing device;
receiving, at the computing device, a request for website content from a website;
determining, at the computing device, that a first network interface device of the computing device is a Wi-Fi wireless interface device;
requesting the website content from the website via the first network interface device;
receiving first received content via the first network interface device in response to requesting the website content from the website via the first network interface device; and
based on detecting that the first network interface device is connected to an untrusted Wi-Fi network, performing, at the computing device, a security action comprising:
requesting the website content from the website via a second network interface device, that uses a hardware interface technology different from the hardware interface technology of the first network interface device;
receiving second received content via the second network interface device in response to requesting the website content from the website via the second network interface device;
determining that the first received content and the second received content are different;
identifying a degree of mismatch associated with the difference between the first received content and the second received content;
identifying a probability of web content manipulation based on the degree of mismatch between the first received content and the second received content; and
determining whether the probability of web content manipulation exceeds the threshold.

2. The computer-implemented method of claim 1, wherein
the second network interface device comprises a cellular wireless interface device, a Bluetooth-compatible wireless interface device, or a Wi-Fi wireless interface device.

3. (canceled)

4. The computer-implemented method of claim 1, wherein the security action is performed randomly when the second network interface device is a cellular wireless interface device.

5. The computer-implemented method of claim 1, further comprising:
receiving an indication the website is compromised; and
performing the security action in response to receiving the indication the website is compromised.

6. The computer-implemented method of claim 1, further comprising using:
a first virtual private network connection to request the website content from the website via the first network interface device; and
a second virtual private network connection to request the website content from the website via the second network interface device.

7. The computer-implemented method of claim 1, wherein the comparing further comprises comparing HyperText Markup Language code between the first received content and the second received content.

8. The computer-implemented method of claim 1, wherein the comparing further comprises comparing JavaScript code between the first received content and the second received content.

9. The computer-implemented method of claim 1, wherein the security action further comprises excluding advertising content from at least one of the first received content or the second received content prior to performing the comparing.

10. The computer-implemented method of claim 1, wherein probability of a presence of web content manipulation is high when JavaScript in the first received content does not match JavaScript in the second received content.

11. The computer-implemented method of claim 1, wherein the security action further comprises presenting, on a display device and in response to determining that the probability of web content manipulation exceeds the threshold, a message to switch to a virtual private network.

12. The computer-implemented method of claim 1, wherein the security action further comprises disconnecting from at least one of a Wi-Fi network, a Bluetooth-compatible wireless interface device, or a cellular network in response to determining that the probability of web content manipulation exceeds the threshold.

13. A system for identifying website content manipulation, the system comprising:
at least one physical processor; and
physical memory comprising computer-executable instructions that, when executed by the physical processor, cause the physical processor to:
receive, at the system, a value of a threshold for identified differences in received web content that, when exceeded, indicates a potential security risk to a computing device;
receive, at the system, a request for website content from a website;
determine, at the system, that a first network interface device of the computing device is a Wi-Fi wireless interface device;
request the website content from the website via the first network interface device;
receive first received content via the first network interface device in response to requesting the website content from the website via the first network interface device; and
perform, at the system, a security action comprising:
requesting the website content from the website via a second network interface device that uses a hardware interface technology different from the hardware interface technology of the first network interface device;
receiving second received content via the second network interface device in response to requesting the website content from the website via the second network interface device;
determining that the first received content and the second received content are different;
identifying a degree of mismatch associated with the difference between the first received content to the second received content; and
identifying a probability of web content manipulation based on a degree of mismatch between the first received content and the second received content.

14. The system of claim 13, wherein
the second network interface device comprises a cellular wireless interface device, a Bluetooth-compatible wireless interface device, or a Wi-Fi wireless interface device.

15. The system of claim 13, wherein the security action is performed randomly when the second network interface device is a cellular wireless interface device.

16. The system of claim 13, wherein the security action further comprises excluding advertising content from at least one of the first received content or the second received content prior to performing the comparing.

17. A non-transitory computer-readable medium comprising one or more computer-executable instructions that, when executed by at least one processor of a computing device, cause the computing device to:
receive a value of a threshold for identified differences in received web content that, when exceeded, indicates a potential security risk to the computing device;
receive, at the computing device, a request for website content from a website;
determine that a first network interface device of the computing device is a Wi-Fi wireless interface device;
request the website content from the website via the first network interface device;
receive first received content via the first network interface device in response to requesting the website content from the website via the first network interface device; and
perform, at the computing device, a security action comprising:
requesting the website content from the website via a second network interface device that uses a hardware interface technology different from the hardware interface technology of the first network interface device;
receiving second received content via the second network interface device in response to requesting the website content from the website via the second network interface device;
determining that the first received content and the second received content are different;
identifying a degree of mismatch associated with the difference between the first received content to the second received content; and
identifying a probability of web content manipulation based on a degree of mismatch between the first received content and the second received content.

18. The non-transitory computer-readable medium of claim 17, wherein
the second network interface device comprises a cellular wireless interface device, a Bluetooth-compatible wireless interface device, or a Wi-Fi wireless interface device.

19. The non-transitory computer-readable medium of claim 17, wherein the security action is performed randomly when the second network interface device is a cellular wireless interface device.

20. The non-transitory computer-readable medium of claim 17, wherein the security action further comprises excluding advertising content from at least one of the first received content or the second received content prior to performing the comparing.

21. The method of claim 1, wherein determining that the first received content and the second received content are different comprises:
comparing, on a character-by-character basis, code included in the first received content with code included in the second received content; and
identifying per-character mismatches between the code included in the first received content and the code included in the second received content.

22. The method of claim 21, wherein the degree of mismatch associated with the difference between the first received content and the second received content increases as a number of identified per-character mismatches between the code included in the first received content with the code included in the second received content increases.
